(19) United States
(12) Patent Application Publication
(10) Pub. No.: US 2021/0272107 A1
(43) Pub. Date: Sep. 2, 2021

(54) DIGITAL CURRENCY PAYMENT SYSTEM, PAYMENT METHOD AND PAYMENT APPARATUS

(71) Applicants: Beijing Bigcode Technology Co., Ltd., Beijing (CN); Beijing Sigone Investment Co., Ltd., Beijing (CN)

(72) Inventors: Wei SHEN, Beijing (CN); Liduo ZHONG, Beijing (CN)

(21) Appl. No.: 17/256,603

(22) PCT Filed: Sep. 17, 2018
(86) PCT No.: PCT/CN2018/106051

§ 371 Date: Dec. 28, 2020

(30) Foreign Application Priority Data
Jun. 28, 2018 (CN) 201810693150.3

(51) Int. Cl. G06Q 20/38; G06Q 20/06; G06Q 20/32; G06Q 20/40; H04L 29/06; H04L 9/32

(52) U.S. Cl. CPC G06Q 20/389; G06Q 20/0655; G06Q 20/3226; G06Q 20/3224; G06Q 20/4015; G06Q 20/3274; H04L 2209/56; G06Q 20/3229; G06Q 20/3829; H04L 63/083; H04L 9/3239; H04L 2209/38; G06Q 20/3278

(57) ABSTRACT

A digital currency payment system, includes: a payment apparatus, a settlement terminal, a digital currency block chain and a network server, wherein the digital currency block chain records each transaction in the form of a block chain; the network server stores related information associated with user information and generates matched information according to the user information; the payment apparatus carries payment information; and the settlement terminal includes: a payment information input module, a field decomposition module, a verification module and a transaction information generation module, wherein the payment information input module acquires the payment information by the payment apparatus, and the field decomposition module decomposes the payment information into fields; and the verification module sends user information in a second field to the network server, and the transaction information generation module generates the transaction recorded in the digital currency block chain after acquiring the verification and authorization.

### CROSS-REFERENCE TO RELATED APPLICATIONS

This application is a national stage application of PCT/CN2018/106051. This application claims priorities from PCT Application No. PCT/CN2018/106051, filed Sep. 17, 2018, and from the Chinese patent application 201810693150.3 filed Jun. 28, 2018, the content of which is incorporated herein in the entirety by reference.

### FIELD

The present invention relates to a digital currency payment system, payment method and payment apparatus.

### BACKGROUND

A block chain technology is also called a distributed ledger technology, which is characterized by decentralization. Due to use of distributed accounting and storage, a data block in a system is jointly maintained by nodes with maintaining functions in a whole system, no centralized hardware and management mechanisms. The information is highly transparent. Human intervention is eliminated. And stability and reliability of data are greatly improved. In recent years, the block chain technology has rapidly developed and has been widely used in the fields of digital currencies, asset certification, evidence preservation, etc.

Prior art 1 (publication number: licensed publication 2018-28762) discloses a technology for payment utilizing a block chain technology. As shown in FIG. 8, a user terminal 21 and a merchant terminal 22 are separately connected with a block chain system 20 through a network NW. And a cash coupon management system 10 manages a cash coupon in the block chain system 20 through the network NW. When the cash coupon is used for payment, the user terminal 21 sends an instruction of using the cash coupon to the block chain system 20 through the network NW. The block chain system 20 sends an acknowledgement instruction to the cash coupon management system 10 according to the instruction. And the cash coupon management system 10, after verifying that a merchant supports the cash coupon, notifies the block chain system 20 of generation of a transaction of cash coupon moving.

Prior art 2 (publication number: licensed publication 2017-204070) discloses a use license to use a block chain technology for managing a video product and a technology for payment using a digital currency.

FIG. 9 is a system diagram of the use license to use the block chain technology for managing the video product and the technology for payment using the digital currency. As shown in FIG. 9, a system comprises a playing apparatus (a user apparatus) 1, a medium management block chain BC2, a management apparatus (a right holder apparatus) 2, and a virtual currency block chain BC1. When a user uses a video product, the playing apparatus 1 is operated to send an application to the medium management block chain BC2. And the application, as a transaction, includes a hash address for payment and information of a displayed program. The medium management block chain BC2, after verifying the transaction, sends a license request to the management apparatus 2. After licensed by the management apparatus 2, a transaction is generated based on the hash address. The transaction, after broadcast in the virtual currency block chain BC1, is connected with an end of the block chain in a block form. The playing apparatus 1 can use the video product on account of a license obtained.

In the prior arts 1 and 2, in a transaction process, synchronization of data and independent verification of the transaction by different nodes are required, such that relatively-long time is required for generating the block in the block chain. It takes ten minutes to complete the transaction of Bitcoin, resulting in bad user experience.

In addition, when the transaction is generated, the user terminal 21, the cash coupon management system 10, the displaying apparatus (the user apparatus) 1 and the management apparatus (the right holder apparatus) 2 are all required to be online, that is, to be connected with the block chain system 20 and the virtual currency block chain BC1. Therefore, the cash coupon or a virtual currency must rely on the network when used for payment, and cannot be used offline in other words, which limits an application of the digital currency in the block chain.

An objective of the present invention is to solve the above problems in the prior arts, and provide a digital currency payment system, payment method and payment apparatus which are simple in payment and may pay without a network environment (offline payment).

### SUMMARY

A first technical solution is a digital currency payment system, wherein the system includes a payment apparatus 1, a settlement terminal 2, a digital currency block chain 3, and a network server 4,

wherein the digital currency block chain 3 is configured for recording each transaction in a block chain manner,

the network server 4, in which relevant information related to user information S stored, is configured for generating matched information based on the user information S,

the payment apparatus 1 is configured for providing payment information, wherein the payment information at least includes two-field information, the first field information including the first address D1 of the digital currency block chain 3, and the second field information including the user information S,

the settlement terminal 2 includes a payment information input module 21, a field decomposition module 22, a verification module 23 and a transaction information generation module 24,

wherein the payment information input module 21 is configured for acquiring the payment information through the payment apparatus 1 in an optical or non-optical manner,

the field decomposition module 22 is configured for decomposing the payment information to acquire the first field information and the second field information,

the verification module 23 is configured for sending user information S in the second field to the network server 4, acquiring the matched information sent by the network server 4, and verifying an authorization to generate a transaction recorded in the digital currency block chain 3 by using the first address based on the matched information, and

the transaction information generation module 24 is configured for generating the transaction, the transaction including a transfer amount, the first address D1 used for transferring-out, and the second address D2 for transferring-in, and

the digital currency block chain 3 is configured for recording the transaction in the block chain in a block manner.

A second technical solution is based on the first technical solution, wherein

the matched information of the network server 4 includes a password,

and the verification module 23 is configured for determining whether a password input by a user is correct, based on the password in the matched information, and verifying the authorization to generate the transaction recorded in the digital currency block chain 3 by using the first address.

A third technical solution is based on the first technical solution, wherein

the matched information of the network server 4 includes a mobile phone number, and

the verification module 23 is configured for sending a verification code to the mobile phone number based on the mobile phone number in the matched information, determining whether a verification code input by the user is correct, and verifying the authorization to generate the transaction recorded in the digital currency block chain 3 by using the first address.

A fourth technical solution is based on any one of the first technical solution to the third technical solution, wherein

the matched information of the network server 4 includes time or/and position information, and

the verification module 23 is configured for verifying whether the transaction is performed at specified time or/and a specified position based on time or/and a position of the matched information as well as current time or/and a current position of the payment apparatus 1.

A fifth technical solution is based on the first technical solution, wherein

the first field includes network address information, and the first address D1 is included in the network address information.

A sixth technical solution is based on the fifth technical solution, wherein

the second field includes network address information, and the user information S is included in the network address information.

A seventh technical solution is based on the first technical solution or the sixth technical solution, wherein the second field information is encoded or encrypted information.

An eighth technical solution is based on the seventh technical solution, wherein

the second field includes control information requiring password input.

The ninth technical solution is a digital currency payment apparatus, wherein

the payment apparatus 1 includes an information carrier 11 and payment information 12 stored on the information carrier, the payment information at least includes two-field information, the first field information including the first address D1 of a digital currency block chain 3, the second field information including user information S, and the user information S having a subordinate relationship with the first address D1, and being configured for verifying an authorization to generate a transaction by using the first address.

A tenth technical solution is based on the ninth technical solution, wherein

the payment information 12 is printed or displayed on the information carrier in the form of a graphic code, the graphic code at least including a two-dimensional code such as a QR code or a bar code, and being read by utilizing an optical reader.

An eleventh technical solution is based on the ninth technical solution, wherein

the information carrier 11 is a storage chip, in which the payment information 12 is stored, the storage chip at least including any one of an NFC chip, an RFID chip, an SIM card and an SD card, and being read by utilizing a near field or directly inserting a reading apparatus.

A twelfth technical solution is based on the tenth technical solution, wherein

the payment apparatus 1 includes a storage module 13, a payment information generation module 14 and a display module 16, the storage module 13 being configured for storing a secret key and the user information S, the payment information generation module 14 being configured for generating the first address D1 by utilizing the secret key, and generating the first field information including the first address and the second field information including the user information S, and the display module 16 being configured for displaying and updating the payment information in the form of the graphic code.

A thirteenth technical solution is a digital currency payment method, wherein the method includes the following steps:

a reading step, in which payment information on a payment apparatus 1 is read, wherein the payment information at least includes two-field information, first field information including the first address D1 of a digital currency block chain 3, and second field information including user information S,

a field information decomposition step, in which the payment information is decomposed to acquire the first field information and the second field information,

a verification step, in which user information S in the second field is sent to a network server 4, matched information sent by the network server 4 is acquired, and an authorization to generate a transaction recorded in the digital currency block chain 3 by using the first address is verified based on the matched information,

a transaction information generation step, in which the transaction is generated, the transaction comprising a transfer amount, the first address D1 used for transferring-out, and the second address D2 used for transferring-in, and

the generated transaction is sent to the digital currency block 3 to be recorded in the block chain in a block manner.

A fourteenth technical solution is based on the thirteenth technical solution, wherein

in the verification step, whether a password in the matched information is consistent with a password input by a user is verified.

A fifteenth technical solution is based on the thirteen technical solution, wherein

in the verification step, based on a mobile phone number in the matched information, a verification code is send to the mobile phone number, and whether a password input by a user is consistent with the sent verification code is verified.

A sixteenth technical solution is based on any one of the thirteenth technical solution to the fifteenth technical solution, wherein

in the verification step, whether time of the transaction is within a specified time period is verified based on time in the matched information and current time.

A seventeenth technical solution is based on any one of the thirteenth technical solution to the sixteenth technical solution, wherein

in the verification step, whether a position of the transaction is within a specified position is verified based on position information in the matched information and a current position of the payment apparatus 1.

### BRIEF DESCRIPTION OF THE DRAWINGS

FIG. 1 is an explanatory diagram of a digital currency payment system;

FIG. 2 is an outline diagram of a payment card;

FIG. 3 is an enlarged diagram of a two-dimensional code of payment information on the payment card;

FIG. 4 is an explanatory diagram for displaying the payment information through a smart phone;

FIG. 5 is a flow chart of a digital currency payment method;

FIG. 6 is a schematic structural diagram of another payment apparatus;

FIG. 7 is an explanatory diagram for displaying the payment information through a user terminal;

FIG. 8 is an explanatory diagram of a prior art 1; and

FIG. 9 is an explanatory diagram of a prior art 2.

### DETAILED DESCRIPTION OF EMBODIMENTS

Hereinafter, particular embodiments are described in details.

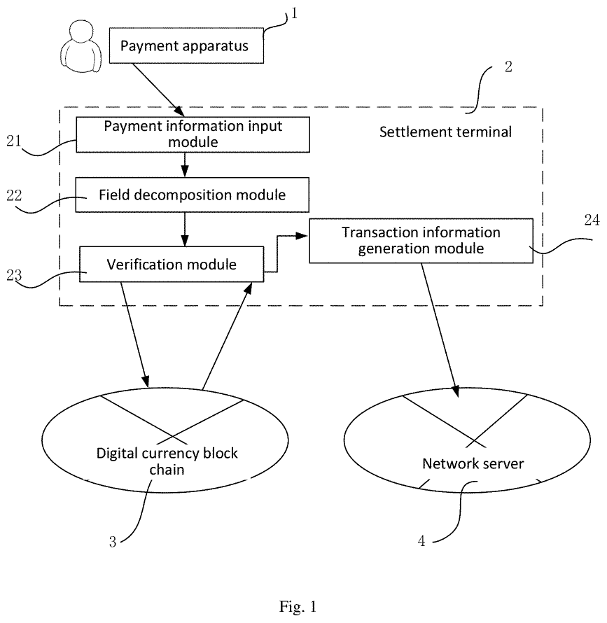

FIG. 1 is an explanatory diagram of a digital currency payment system.

As shown in FIG. 1, the digital currency payment system includes a payment apparatus 1, a settlement terminal 2, a digital currency block chain 3, and a network server 4. In this embodiment, Bitcoin is taken as an example of a digital currency for description.

The digital currency block chain 3 is configured for recording each transaction in a block chain manner, and is a decentralized transaction recording system. After the transaction is broadcast, a block including transaction information is recorded at an end of a block chain. Each transaction may be checked and verified through any node.

The network server 4, in which relevant information related to user information S is stored, is configured for generating matched information based on the user information S.

The payment apparatus 1 provides payment information. The payment information includes a first address D1 for transferring out the Bitcoin when the settlement terminal 2 generates a transaction. The payment information at least includes two-field information, the first field information includes the first address D1 (a hash address), the second field information includes the user information S, and the user information S is configured for verifying an authorization of the transaction. In this embodiment, the payment apparatus 1 uses a payment card recognizable to an optical system. Hereinafter, for the convenience of description, unless otherwise stated, the payment apparatus is called a payment card 1 for short. A two-dimensional code as the payment information is printed or displayed on the payment card 1.

The settlement terminal 2 includes a payment information input module 21, a field decomposition module 22, a verification module 23 and a transaction information generation module 24. Corresponding to the payment card 1, the payment information input module 21 uses an optical reading module which is capable of optical reading. Hereinafter, for the convenience of description, unless otherwise stated, the payment information input module is called the optical reading module 21 for short.

The optical reading module 21 is configured for reading the two-dimensional code on the payment card 1 through an optical manner and acquiring the payment information through decoding.

The field decomposition module 22 is configured for decomposing the payment information to acquire the first field information and the second field information.

The verification module 23 is configured for sending user information S in the second field to the network server 4, acquiring the matched information sent by the network server 4, and verifying an authorization to generate a transaction recorded in the digital currency block chain 3 by using the first address D1 based on the matched information,

The transaction information generation module 24 is configured for generating the transaction, and the transaction includes a transferred Bitcoin amount (transfer amount), the first address D1 used for transferring-out, and the second address D2 for transferring-in.

The digital currency block chain 3 is configured for recording the transaction in the block chain in a block manner.

Therefore, during payment, a user only needs to present the payment card 1, a transaction may be generated by reading the two-dimensional code on the payment card 1 through the settlement terminal 2, and the user may pay offline and does not need to wait for a result verifying through the node. Accordingly, user experience for the digital currency is improved.

Hereinafter, the payment card is described.

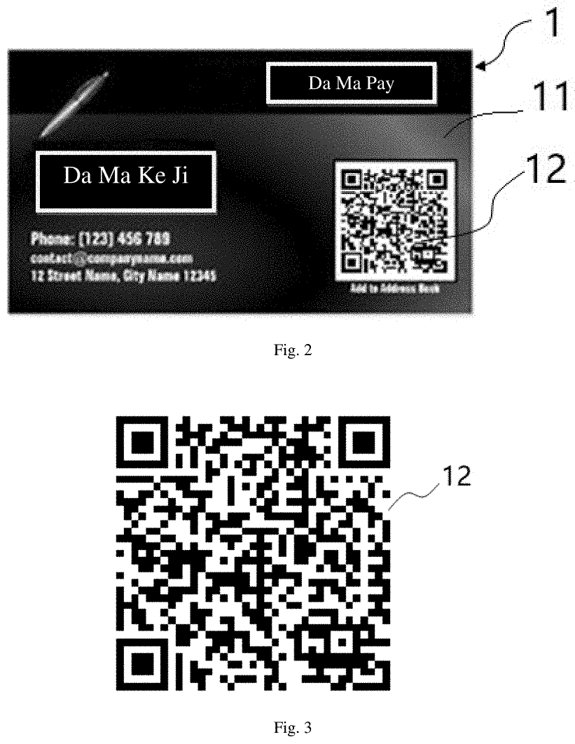

FIG. 2 is an outline diagram of the payment card. As shown in FIG. 2, the payment card 1 takes a card as an information carrier 11, and a QR code (a two-dimensional code) 12 is printed on a surface of the card to serve as the payment information.

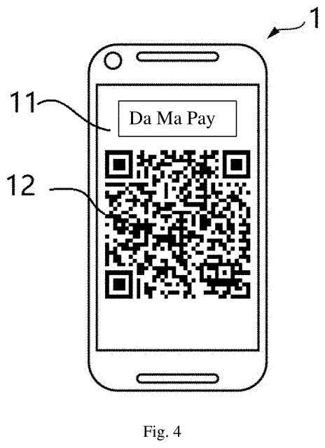

FIG. 3 is an enlarged diagram of the QR code 12 on the payment card 1, and the QR code 12 includes two-field information and may be read through an optical reader. For example, the following payment information is coded in the QR code 12:

http://www.bitcoin.com/abc/XE23KQBMCX8SE31S5K8UA1TJC0340R10P5F?http://www.xcoin.com/bcd/WD45VFG34P

The information is formed by two fields, the first field is

http://www.bitcoin. com/abc/XE23KQBMCX8SE31S5K8UA1TJC0340R I0P5F,

the second field is

http://www.xcoin.com/bcd/WD45VFG34P, and

the fields are isolated by a special character “?”, such that the field decomposition module 22 may distinguish the first field information from the second field information by detecting “?”. As a field distinguishing method, besides use of the special character which does not occur in the field, a length of a character string may be used as well to distinguish the first field information from the second field information. The second field information is also encoded or encrypted information.

The first field is a network address, which includes the first address D1 in the digital currency block chain 3, namely an address of the user in the digital currency block chain 3.

The second field is another network address, which includes the user information S.

In the above embodiment, the payment information is printed in the form of a QR code on the card serving as the information carrier. However, the payment information may be directly stored in a storage chip for use, that is, the storage chip is taken as the information carrier to store the payment information.

The storage chip may be a chip of any form, such as an NFC chip, an RFID chip, an SIM card and an SD card which are often used, and may be read by utilizing a near field or by directly inserting into a reading apparatus, that is, the payment information input module 21 corresponding to the storage chip is used for replacing the optical reading module and inputting the payment information.

In this embodiment, the information carrier 11 of the payment card 1 is the card, but the information carrier 11 may be a display screen alternatively.

FIG. 3 is an explanatory diagram for displaying the payment information 12 by utilizing the display screen of a smart phone,

That is, the smart phone is used as the payment apparatus 1, the payment information 12 is stored in the smart phone, during payment, the smart phone may be operated to display the QR code 12 on the display screen so as to pay like the payment card 1, and a user with a smart phone does not need to carry the payment card additionally, thereby improving convenience of the user.

### Embodiment 1

Matched information of a network server 4 includes a password, and a verification module 23 is configured for determining whether a password input by a user is correct, and verifying an authorization based on the password in the matched information 23.

### Embodiment 2

Matched information of a network server 4 includes a mobile phone number, a verification module 23 is configured for sending a verification code to the mobile phone number based on the mobile phone number in the matched information, determining whether a verification code input by a user is correct, and verifying an authorization.

### Embodiment 3

Matched information of a network server 4 includes time or/and position information, and a verification module 23 is configured for verifying an authorization based on the time or/and the position of the matched information as well as current time or/and a transaction position, namely verifying whether payment is performed during the set period or/and in the specified region by setting a use period or/and a transaction position of Bitcoin. The transaction position may be determined based on a position of a payment card 1. Due to the fact that the payment card 1 is at a short distance from a settlement terminal 2, the position of the payment card 1 may be determined by utilizing a position of the settlement terminal 2, such that additional setting of other means for determining the position of the payment card 1 is not needed any more, thereby simplifying a structure.

To improve safety, the second field information may be encoded or encrypted ciphertext information.

Control information requiring password input may be added to the second field as well.

Hereinafter, a digital currency payment method is described.

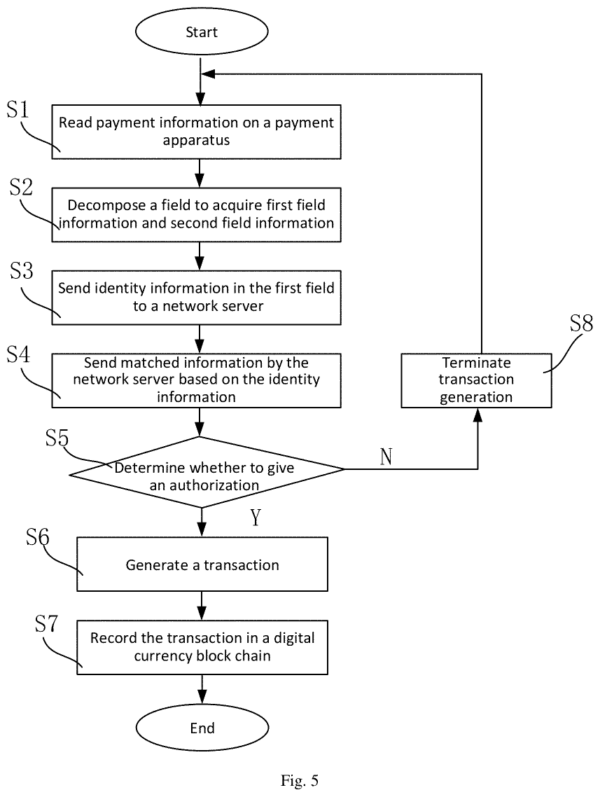

FIG. 5 is a flow chart of the payment method.

In step S1 (a reading step), the settlement terminal 2 is configured for reading a two-dimensional code on the payment card 1 through an optical reading module 21 to acquire payment information through decoding.

In step S2 (a field decomposition module), a special character “?” is detected, so as to decompose the payment information into the first field information and the second field information.

In step S3, user information S in the second field is sent to the network server 4.

In step S4, the network server 4, is configured for searching for, based on the user information S, the matched information related to the user information, and sending the matched information to the settlement terminal 2.

In step S5, the settlement terminal 2 is configured for acquiring the matched information sent by the network server 4, and then verifying an authorization to generate a transaction recorded in a digital currency block chain 3 by using the first address based on the matched information. That is, if the matched information is a password, the password is compared with a password input, and the authorization is deemed to be given when they are consistent. If the matched information is a mobile phone number, a verification code is sent to the mobile phone number, the verification code is compared with a verification code input, and the authorization is deemed to be given when they are consistent.

If the matched information includes the time and position, whether the condition is met is determined as well based on the current time and the position during payment of the payment card 1.

If the conditions in the matched information are all met or consistent, the authorization is deemed to be given and step S6 is executed.

In step S6, the settlement terminal 2 is configured for generating the transaction, which includes a transfer amount, the first address D1 used for transferring-out, and the second address D2 used for transferring-in.

In step S7, a transaction is sent to network and is recorded in the digital currency block chain 3 after verified by a node.

Steps 3-5 constitute verification steps in the claims.

Hereinafter, other embodiments of the payment apparatus 1 are described.

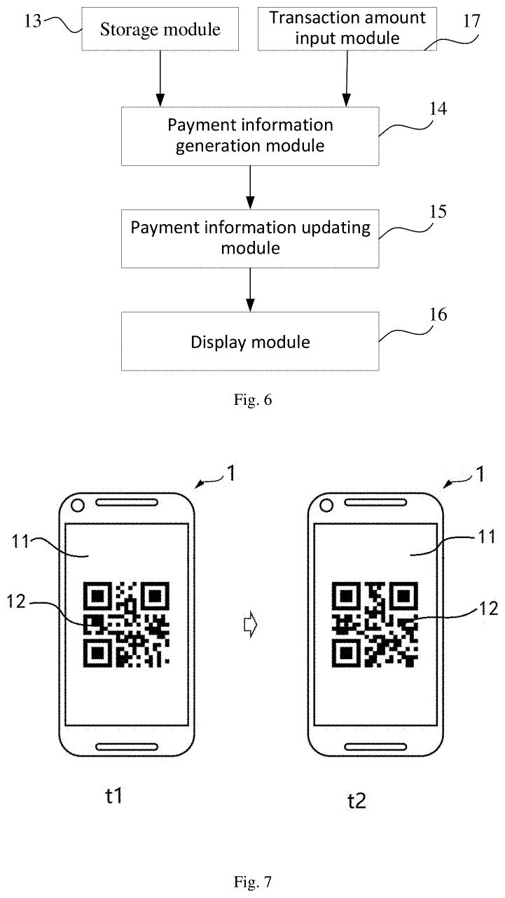

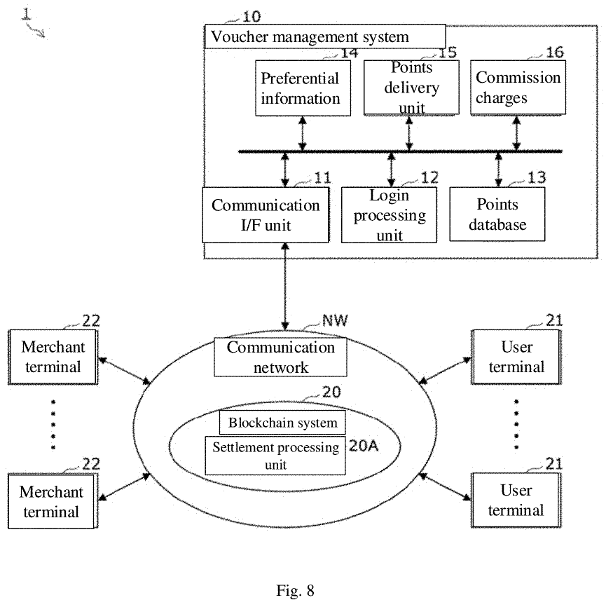

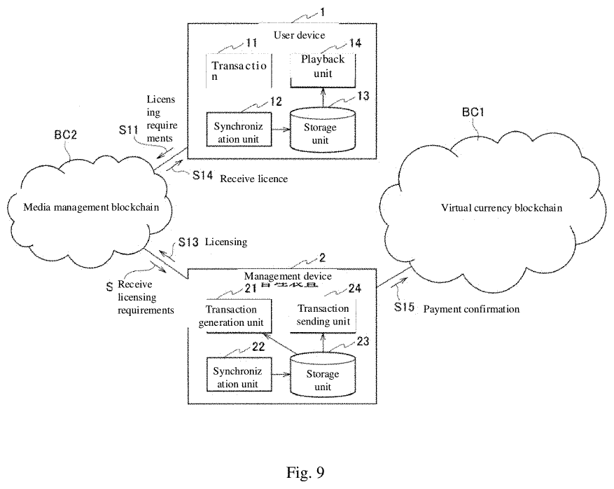

FIG. 6 is an explanatory diagram of a payment apparatus.

The payment apparatus 1 includes a storage module 13, a payment information generation module 14, a liquid crystal display module 16 and a transaction amount input module 17. The payment apparatus 1 may be an independent apparatus, or may be arranged in a smart phone for use, and utilizes a liquid crystal display screen of the smart phone for displaying payment information.

A secret key and user information S are stored in the storage module 13. The payment information generation module 14 utilizes the secret key to generate the first address D1 and generate the payment information. The payment information includes first field information including the first address D1, second field information including the user information S and a transaction amount inputting by the transaction amount input module 17. The liquid crystal display module 16 is configured for displaying the payment information and updating the payment information in the form of a QR code.

That is, compared with an embodiment of FIG. 1, the transaction amount is input by the payment apparatus 1 instead of the settlement terminal 2.

Therefore, as shown in FIG. 7, a QR code pattern displayed for payment at time t1 is changed from a QR code pattern displayed for payment at time t2, such that the liquid crystal display module 16 displays different QR code patterns each time, thereby further enhancing security compared with a payment card. As the payment apparatus 1, the transaction amount input module 17 is not essential, for example, any other changing information such as transaction time information may also be added only if the QR code pattern generated each time may change. The liquid crystal display module 16 may be replaced with a module in another manner as well, for example, a bluetooth, NEC or WIFI module may be used for outputting the payment information.

The particular implementations and embodiments of the present invention are described as above. The present invention may be subjected to any other change, for example, the digital currency in the implementation uses Bitcoin, but may use a digital currency of any other form only if the digital currency adopts the block chain technology, and any modification within a technical idea of the present invention belongs to the scope of the present invention.

1. A digital currency payment system, comprising:
a payment apparatus (1), a settlement terminal (2), a digital currency block chain (3), and a network server (4),
the digital currency block chain (3) is configured for recording each transaction in a block chain manner,
the network server (4), in which relevant information related to user information (S) is stored, is configured for generating matched information based on the user information (S),
the payment apparatus (1) is configured for providing payment information, wherein the payment information at least comprises two-field information, the first field information comprising the first address (D1) of the digital currency block chain (3), and the second field information comprising the user information (S),
the settlement terminal (2) comprises a payment information input module (21), a field decomposition module (22), a verification module (23) and a transaction information generation module (24),
wherein the payment information input module (21) is configured for acquiring the payment information through the payment apparatus (1) in an optical or non-optical manner,
the field decomposition module (22) is configured for decomposing the payment information to acquire the first field information and the second field information,
the verification module (23) is configured for sending user information (S) in the second field to the network server (4), acquiring the matched information sent by the network server (4), and verifying an authorization to generate a transaction recorded in the digital currency block chain (3) by using the first address based on the matched information, and
the transaction information generation module (24) is configured for generating the transaction, the transaction comprising a transfer amount, the first address (D1) used for transferring-out, and the second address (D2) for transferring-in, and
the digital currency block chain (3) is configured for recording the transaction in the block chain in a block manner.

2. The digital currency payment system according to claim 1, wherein
the matched information of the network server (4) comprises a password,
and the verification module (23) is configured for determining whether a password input by a user is correct, based on the password in the matched information, and verifying the authorization to generate the transaction recorded in the digital currency block chain (3) by using the first address.

3. The digital currency payment system according to claim 1, wherein
the matched information of the network server (4) comprises a mobile phone number, and
the verification module (23) is configured for sending a verification code to the mobile phone number based on the mobile phone number in the matched information, determining whether a verification code input by the user is correct, and verifying the authorization to generate the transaction recorded in the digital currency block chain (3) by using the first address.

4. The digital currency payment system according to claim 1, wherein
the matched information of the network server (4) comprises time or/and position information, and
the verification module (23) is configured for verifying whether the transaction is performed at specified time or/and a specified position based on time or/and a position of the matched information as well as current time or/and a current position of the payment apparatus (1).

5. The digital currency payment system according to claim 1, wherein
the first field comprises network address information, and the first address (D1) is included in the network address information.

6. The digital currency payment system according to claim 5, wherein
the second field comprises network address information, and the user information (S) is included in the network address information.

7. The digital currency payment system according to claim 6, wherein the second field information is encoded or encrypted information.

8. The digital currency payment system according to claim 7, wherein the second field comprises control information requiring password input.

9. A digital currency payment apparatus, wherein
the payment apparatus (1) comprises an information carrier (11) and payment information (12) stored on the information carrier, the payment information at least comprises two-field information, the first field information comprising the first address (D1) of a digital currency block chain (3), the second field information comprising user information (S), and the user information (S) having a subordinate relationship with the first address (D1), and being configured for verifying an authorization to generate a transaction by using the first address.

10. The payment apparatus according to claim 9, wherein
the payment information (12) is printed or displayed on the information carrier in the form of a graphic code, the graphic code at least comprising a two-dimensional code such as a QR code or a bar code, and being read by utilizing an optical reader.

11. The payment apparatus according to claim 9, wherein
the information carrier (11) is a storage chip, in which the payment information (12) is stored, the storage chip at least comprising any one of an NFC chip, an RFID chip, an SIM card and an SD card, and being read by utilizing a near field or directly inserting a reading apparatus.

12. The payment apparatus according to claim 10, wherein
the payment apparatus (1) comprises a storage module (13), a payment information generation module (14) and a display module (16), the storage module (13) being configured for storing a secret key and the user information (S), the payment information generation module (14) being configured for generating the first address (D1) by utilizing the secret key, and generating the first field information including the first address (D1) and the second field information including the user information (S), and the display module (16) being configured for displaying and updating the payment information in the form of the graphic code.

13. A digital currency payment method, comprising the following steps:
a reading step, in which payment information on a payment apparatus (1) is read, wherein the payment information at least comprises two-field information, first field information comprising the first address (D1) of a digital currency block chain (3), and the second field information comprising user information (S),
a field decomposition step, in which the payment information is decomposed to acquire the first field information and the second field information,
a verification step, in which user information in the second field is sent to a network server (4), matched information sent by the network server (4) is acquired, and an authorization to generate a transaction recorded in the digital currency block chain (3) by using the first address is verified based on the matched information,
a transaction information generation step, in which the transaction is generated, the transaction comprising a transfer amount, the first address (D1) used for transferring-out, and the second address (D2) for transferring-in, and
the generated transaction is sent to the digital currency block chain (3) to be recorded in the block chain in a block manner.

14. The digital currency payment method according to claim 13, wherein
in the verification step, whether a password in the matched information is consistent with a password input by a user is verified.

15. The digital currency payment method according to claim 13, wherein in the verification step, based on a mobile phone number in the matched information, a verification code is sent to the mobile phone number, and whether a verification code input by a user is consistent with the verification code sent is verified.

16. The digital currency payment method according to claim 13, wherein
in the verification step, whether time of the transaction is within a specified time period is verified based on time in the matched information and current time.

17. The digital currency payment method according to claim 13, wherein
in the verification step, whether a position of the transaction is within a specified position is verified based on position information in the matched information and a current position of the payment apparatus (1) or a current position of the settlement terminal (2).

18. The digital currency payment system according to claim 2, wherein
the matched information of the network server (4) comprises time or/and position information, and
the verification module (23) is configured for verifying whether the transaction is performed at specified time or/and a specified position based on time or/and a position of the matched information as well as current time or/and a current position of the payment apparatus (1).

19. The digital currency payment system according to claim 3, wherein
the matched information of the network server (4) comprises time or/and position information, and
the verification module (23) is configured for verifying whether the transaction is performed at specified time or/and a specified position based on time or/and a position of the matched information as well as current time or/and a current position of the payment apparatus (1).
